(19) United States
(12) Patent Application Publication
(10) Pub. No.: US 2026/0181615 A1
(43) Pub. Date: Jun. 25, 2026

(54) POWER CONSUMPTION BASED MOBILITY FOR WIRELESS DEVICES

(71) Applicant: Apple Inc., Cupertino, CA (US)

(72) Inventors: Lijie ZHANG, Beijing (CN); Jishan GAO, Beijing (CN); Shangfeng LI, Beijing (CN); Zhiwei WANG, Beijing City (CN)

(21) Appl. No.: 19/119,060

(22) PCT Filed: Nov. 8, 2022
(86) PCT No.: PCT/CN2022/130650

§ 371 Date: Apr. 7, 2025

(51) Int. Cl. H04W 72/0453; G06F 1/3203; H04W 36/00

(52) U.S. Cl. CPC H04W 72/0453; G06F 1/3203; H04W 36/0061

(57) ABSTRACT

This application describes techniques to determine radio access technology (RAT) priorities for a wireless device and to manage mobility of the wireless device between serving cells and target cells based on one or more power consumption based metrics, which can be measured and/or estimated by the wireless device and/or by a cellular wireless network entity. Exemplary metrics include power consumption rates, cumulative total power consumption, battery levels, cumulative voice connection time, and estimated remaining call time. The wireless device compares one or more metrics against corresponding thresholds to determine whether to trigger a handover or reselection (for mobility) or to prioritize use of a particular RAT during a time period. In some embodiments, threshold values are scaled based on an amount of time remaining in the time period or on a battery power level of the wireless device.

### FIELD

The described embodiments set forth techniques to determine radio access technology (RAT) priorities and to manage mobility between serving cells and target cells based on actual and/or estimated power consumption by a wireless device.

### BACKGROUND

Wireless devices are configured to use removable Universal Integrated Circuit Cards (UICCs) that include subscriber identity modules (SIMs) and/or electronic SIMs (eSIMs) installed on an embedded universal integrated circuit card (eUICC) of the mobile device, the SIMs and/or eSIMs enabling the wireless devices to access services provided by Mobile Network Operators (MNOs), which may also be referred to as carriers. An MNO can deploy cellular wireless networks using different radio access technologies (RATs), upgrading their cellular wireless networks to use newer wireless communication standards that provide improved performance, such as higher data rates, lower latency, and new services. The MNO can install an overlay cellular wireless network that uses a newer RAT, e.g., a fifth generation (5G) new radio (NR) cellular wireless network in parallel with an existing cellular wireless network that uses an older RAT, e.g., a fourth generation (4G) long term evolution (LTE) cellular wireless network. A SIM or eSIM for the MNO can provide access to cellular wireless services of the MNO via the 4G LTE wireless network and/or the 5G NR wireless network. A carrier configuration file associated with the SIM/eSIM for the MNO can prioritize cellular wireless connections based on priorities set by the MNO, e.g., prefer use of the 5G NR wireless network over use of the 4G LTE wireless network. Additionally, the MNO can control reselection (while in the wireless device is in an idle state) or handover (while the wireless device is in a connected state) between a serving cell and a target cell based on signal strength and/or signal quality. Communication with different cells, particularly cells using different RATS, however, can require different amounts of transmit power by the wireless device and result in different amounts of power consumption by the wireless device. There exists a need to manage RAT prioritization and cell mobility by a wireless device based on power consumption by the wireless device.

### SUMMARY

The described embodiments set forth techniques to determine radio access technology (RAT) priorities and to manage mobility between serving cells and target cells based on actual and/or estimated power consumption by a wireless device. A serving cell on which a wireless device is camped or connected may cause the wireless device to consume power at a higher rate than a neighbor cell. Power consumption by the wireless device can vary based on a radio frequency (RF) band and a bandwidth used for communication with a cellular wireless network. Higher bandwidth cells can require greater power consumption than lower bandwidth cells, and far cell conditions can require a wireless device to transmit at elevated power levels increasing power consumption by the wireless device. The wireless device can use measurements of received signals for different RF bands and/or different RATs to estimate transmit power levels required for a serving cell and for one or more neighbor cells. The wireless device can map the estimated transmit power levels to estimated power consumption values for the wireless device when connected with the various cells. The wireless device can trigger a potential handover or reselection to a neighbor cell when a power consumption differential between the serving cell and the neighbor cell satisfies one or more criteria. In some embodiments, the wireless device provides a measurement report with priority to a cellular wireless network when the one or more criteria are satisfied. In some embodiments, the wireless device blocks sending a measurement report to a cellular wireless network when the one or more criteria are not satisfied. In some embodiments, the wireless device reports received signal measurements for a serving cell and one or more neighbor cells and a power headroom report (PHR) to a cellular wireless network, and the cellular wireless network estimates transmit power levels and resulting power consumption for the wireless device for remaining on the serving cell and for moving to a neighbor cell. When a power consumption differential between the neighbor cell and the serving cell satisfies one or more criteria, the cellular wireless network can cause the wireless device to reselect or handover from the serving cell to the neighbor cell. In some embodiments, the wireless device maintains a mapping of transmit power levels to estimated power consumption by a transmit power amplifier of the wireless device. In some embodiments, the wireless device and/or the cellular wireless network refrains from triggering a power consumption based reselection or handover from a serving cell to a neighbor cell when the estimated transmit power levels for the wireless device in the serving cell and in the neighbor cell both fall below a transmit power level threshold value. In some embodiments, when estimated power consumption for the wireless device in a serving cell and a neighbor cell differ by less than a power consumption difference threshold level, the wireless device and/or the cellular wireless network perform handover and/or reselection procedures based on signal strength and/or signal quality measurements. In some embodiments, a wireless device monitors one or more metrics and determines whether to prioritize a first RAT, e.g., 5G NR, or a second RAT, e.g., 4G LTE, to use for voice connections by the wireless device with a cellular wireless network. In some embodiments, the wireless device monitors one or more of: an estimated amount of remaining continuous voice call time for the wireless device, a cumulative amount of active voice call time by the wireless device during a time period, or a cumulative amount of power consumption by the wireless device during a time period. The wireless device can prioritize voice connections to use the first RAT, e.g. via VoNR, over the second RAT, e.g., via VoLTE, or vice versa depending on the monitored metrics. In some embodiments, the wireless device compares one or more of the monitored metrics to corresponding thresholds, which can be fixed or scaled across the time period, and determines whether to prioritize the first or second RAT for voice connections accordingly. A scaled threshold value for a monitored metric can increase or decrease during the time period (based on whether the respective metric increases or decreases through the time period) to allow for the wireless device to remain using a particular RAT, e.g., VoNR, for a longer period of time during the time period. In some embodiments, the wireless device resets monitored metrics for each successive time period, such as at the start of each day or at a designated time each day.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a diagram of different components of an exemplary cellular wireless network with overlapping radio access technologies (RATs) configured to implement the various techniques described herein, according to some embodiments.

FIG. 2A illustrates a chart of exemplary battery power consumption relative to transmit power levels for a wireless device in different states, according to some embodiments.

FIG. 2B illustrates a chart of exemplary transmit power amplifier power consumption relative to transmit power levels for a wireless device, according to some embodiments.

FIG. 2C illustrates a table of exemplary power consumption for a wireless device in different states using different RAT configurations, according to some embodiments.

FIG. 2D illustrates a table of exemplary power consumption and continuous talk time for different RATs and network vendor equipment, according to some embodiments.

FIG. 3A illustrates a diagram of an exemplary legacy handover or reselection between a serving cell and a target cell based on received signal measurements, according to some embodiments.

FIG. 3B illustrates a diagram of an exemplary handover or reselection between a serving cell and a target cell based on transmit power or battery power, according to some embodiments.

FIGS. 4A and 4B illustrate diagrams of exemplary RAT prioritization for voice connections based on remaining call time, according to some embodiments.

FIGS. 4C and 4D illustrate diagrams of exemplary RAT prioritization for voice connections based on total call duration, according to some embodiments.

FIGS. 4E and 4F illustrate diagrams of exemplary RAT prioritization for voice connections based on voice call power consumption, according to some embodiments.

FIG. 5 illustrates a flowchart of an exemplary method for power consumption based mobility by a wireless device, according to some embodiments.

FIG. 6 illustrates a flowchart of an exemplary method for adaptive RAT prioritization for voice connections by a wireless device, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments set forth techniques to determine radio access technology (RAT) priorities for a wireless device and to manage mobility of the wireless device between serving cells and target cells based on one or more power consumption based metrics, which can be measured and/or estimated by the wireless device and/or by a cellular wireless network entity. A wireless device, when camped on or connected to a serving cell of a cellular wireless network that uses a particular radio frequency (RF) band or an amount of RF bandwidth for communication, may consume (or estimate to consume) battery power at a higher rate than when the wireless device is camped on or connected to a neighbor cell. Power consumption by the wireless device, when communicating with a cell of a cellular wireless network, can vary based on the RF band used by the and a bandwidth of communication channel used for communication between the wireless device and the cellular wireless network. Cells configured to use higher bandwidth connections can result in the wireless device consuming power at a higher rate than connections to cells that use lower bandwidth connections. A wireless device can also require higher transmit power levels to communicate with a cell when operating in a far cell condition, e.g., within a peripheral region of the cell with high levels of propagation loss for RF signals communicated between the wireless device and the cell, which can cause the wireless device consume higher levels of battery power to support transmissions as the higher transmit power levels required. A cellular wireless network can deploy different types of cells in an overlapping arrangement with some cells using lower frequency bands with longer reach (larger geographic area coverage), and some cells using higher frequency bands with shorter reach (smaller geographic coverage). The cells of the cellular wireless network can also use different RATs that use different RF bands and different bandwidths to provide different potential data throughputs. Generally, a cellular wireless network can configure a wireless device to prioritize using a more recent (later generation) wireless RAT over an earlier (previous generation) wireless RAT when cell selection criteria are met in order to offer higher quality services to the wireless device. In addition, some cellular wireless networks can prioritize using a higher RF band of a wireless RAT over a lower RF band of the wireless RAT. Cell selection criteria used by a cellular wireless network can be based on performance metrics, such as signal strength and signal quality, and may not account for power consumption by a wireless device when connected to different cell types. In some circumstances, the wireless device can prefer to select a wireless RAT (or an RF band of a particular RAT) based on an estimated amount of power consumption that a connection using the wireless RAT (or the RF band of the particular RAT) will incur. In some cases, the wireless device can be configured to prioritize conserving a limited battery power level of the wireless device over using higher data rates or more advanced services when determining a wireless RAT or a serving cell to use.

A wireless device can use periodic measurements of received signals from a serving cell and one or more neighbor cells to estimate transmit power levels required to communicate with the serving cell and with the one or more neighbor cells. The wireless device may measure cells that use different RF bands (inter-band measurements) and/or cells that use different RATs (inter-RAT measurements). The wireless device can account for characteristics of the serving cell and neighbor cells, such as a RAT, an RF band, and/or an RF bandwidth used, along with measurements of received signal performance characteristics, e.g., signal strength, such as reference signal received power (RSRP) values and/or signal quality, such as signal to interference plus noise ratio (SINR) values, to determine required transmit power levels for the wireless device to communicate with the various cells. The wireless device can maintain a database of one or more tables that correlate transmit power levels to battery power consumption. For a presently connected serving cell and potentially connected neighbor cells, the wireless device can map an estimated transmit power level for connection with a cell to an estimated power consumption value should the wireless device connect with the cell. The wireless device can compare an estimated power consumption level for remaining on the serving cell to estimated power consumption levels for switching to one of the neighbor cells. The wireless device can trigger a potential handover or reselection to a neighbor cell when a power consumption differential between the serving cell and the neighbor cell satisfies one or more criteria. In some embodiments, the wireless device calculates a power consumption difference between an estimated power consumption for communicating with the serving cell and an estimated power consumption for communicating with a target neighbor cell. When the power consumption difference plus an offset value exceeds a power consumption difference threshold value, the wireless device can trigger the potential handover or reselection to the target neighbor cell. In some embodiments, the offset value can be based on characteristics of the target neighbor cell, such as a connected mode discontinuous reception (CDRX) configuration, an RF band, and/or an RF bandwidth used by the target neighbor cell.

In some embodiments, the wireless device provides a measurement report with priority to a cellular wireless network when the one or more criteria for the power consumption differential between a serving cell and a target neighbor cell are satisfied. The wireless device provides the measurement report with priority in order to trigger reselection or handover of the wireless device from the serving cell to the target neighbor cell. In some embodiments, the wireless device blocks sending a measurement report to a cellular wireless network when the one or more criteria for the power consumption differential between a serving cell and a target neighbor cell are not satisfied. The wireless device withholds sending the measurement report in order to block reselection or handover of the wireless device from the serving cell to the target neighbor cell.

In some embodiments, the cellular wireless network determines power consumption estimates for the wireless device and uses the power consumption estimates for cell reselection and/or handover. In some embodiments, the wireless device provides received signal performance metrics, e.g., signal strength and/or signal quality measurements, for a serving cell and one or more neighbor cells to the cellular wireless network along with a power headroom report (PHR). The cellular wireless network can use the received signal performance metrics and the PHR to estimate transmit power levels for the wireless device to remain communicating with the serving cell and to switch to communicating with various neighbor cells. The cellular wireless network can estimate a power consumption for the wireless device based on the estimated power transmit power levels and determine a power consumption differential for the wireless device to remain on the serving cell or to switch to a neighbor cell. When a power consumption differential between the serving cell and the neighbor cell satisfies one or more criteria, the cellular wireless network can cause the wireless device to reselect or handover from the serving cell to the neighbor cell.

In some embodiments, the wireless device maintains a database that maps transmit power levels to estimated power consumption by a transmit power amplifier of the wireless device. In some embodiments, offline measurements at different transmit power levels are taken and stored in the wireless device. In some embodiments, power consumption by the transmit power amplifier varies based on transmit power level but is substantially invariant to one or more of: RF bandwidth, RF carrier used within an RF band, or a RAT used. In some embodiments, the wireless device estimates power consumption levels based on transmission of one or more slot level transmissions, e.g., physical uplink control channel (PUCCH) and/or physical uplink shared channel (PUSCH) transmissions. In some embodiments, power consumption by a transmit power amplifier of the wireless device changes modestly at lower transmit power levels (e.g., below a transmit power threshold value) and changes substantially at higher transmit power levels (e.g., above the transmit power threshold value). In some embodiments, the wireless device and/or the cellular wireless network refrains from triggering a power consumption based reselection or handover from a serving cell to a neighbor cell when the estimated transmit power levels for the wireless device in the serving cell and in the neighbor cell both satisfy a transmit power level threshold, e.g., equal or fall below a transmit power level threshold value, such as at/below 10 dBm. When the estimated transmit power level for the wireless device in the serving cell and in a neighbor cell do not exceed the transmit power level threshold, the wireless device can determine the power consumption difference to be negligible, e.g., to be effectively zero. In some embodiments, when estimated power consumption for the wireless device in a serving cell and a neighbor cell differ by less than a power consumption difference threshold level, the wireless device and/or the cellular wireless network perform handover and/or reselection procedures based legacy mechanisms, such as based on signal strength and/or signal quality measurements.

In some embodiments, a wireless device monitors one or more metrics and determines whether to prioritize a first RAT, e.g., 5G NR, or a second RAT, e.g., 4G LTE, to use for voice connections by the wireless device with a cellular wireless network. A mobile network operator (MNO) can prioritize use of a higher performing RAT for voice connections, e.g., voice over NR (VoNR) preferred over voice over LTE (VoLTE), as a user can experience higher data performance during a VoNR call. The MNO can allocate higher bandwidth channels for VoNR connections than for VoLTE connections, which can result in higher power consumption by a wireless device for VoNR over VoLTE. In addition, VoNR can use CDRX settings that remain active for longer periods of time, which also increases power consumption relative to CDRX settings used for VoLTE, which enters a lower power state more rapidly.

In some embodiments, the wireless device monitors one or more of: an estimated amount of remaining continuous voice call time for the wireless device, a cumulative amount of active voice call time by the wireless device during a time period, or a cumulative amount of power consumption by the wireless device during a time period. The wireless device can prioritize voice connections to use the first RAT, e.g., via VoNR, over the second RAT, e.g., via VoLTE, or vice versa depending on the monitored metrics. In some embodiments, the wireless device compares one or more of the monitored metrics to corresponding thresholds, which can be fixed or scaled across the time period, and determines whether to prioritize the first or second RAT for voice connections accordingly. A scaled threshold value for a monitored metric can increase or decrease during the time period (based on whether the respective metric increases or decreases throughout the time period) to allow for the wireless device to remain using a particular RAT, e.g., VoNR, for a longer period of time during the time period. In some embodiments, the wireless device scales the threshold value during the time period based on an amount of time remaining in the time period. In some embodiments, the wireless device scales the threshold based on an amount of battery power available for the wireless device, which can be provided by an applications processor to a wireless communication application resident on the applications processor or on a baseband processor. In some embodiments, the wireless device resets monitored metrics for each successive time period, such as at the start of each day or at a designated time each day.

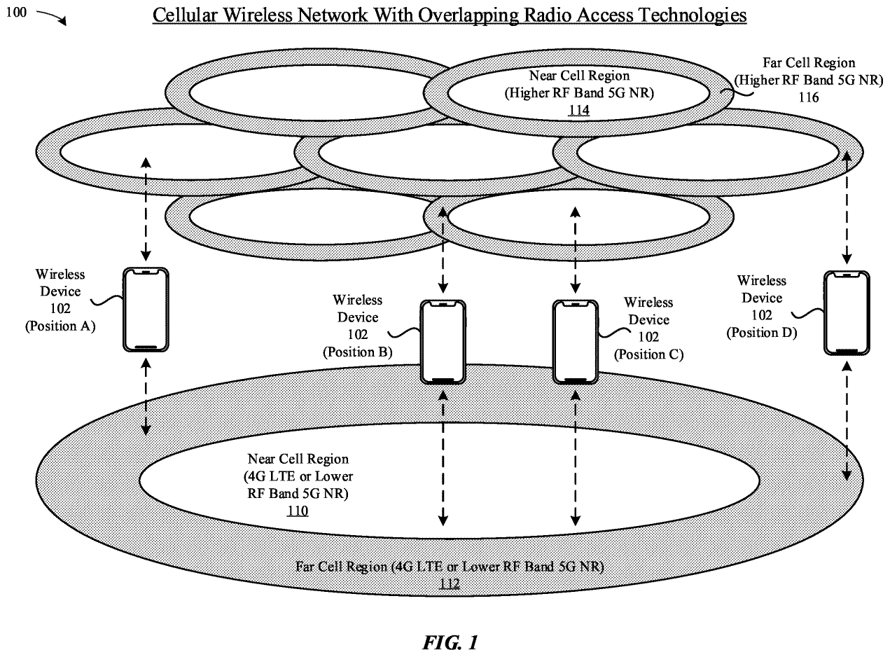

These and other embodiments are discussed below with reference to FIGS. 1-7; however, those skilled in the art will readily appreciate that the detailed description given herein with respect to these figures is for explanatory purposes only and should not be construed as limiting.

FIG. 1 illustrates a diagram 100 of different components of a cellular wireless network with overlapping radio access technologies (RATs) deployed. A wireless device 102 can connect to the cellular wireless network via a first RAT, e.g., a fourth generation (4G) long term evolution (LTE) RAT, or via a second RAT, e.g., a fifth generation (5G) new radio (NR) RAT. The wireless device 102 can represent a mobile computing device (e.g., an iPhone® or iPad® by Apple®) or a cellular-capable wearable device (e.g., an Apple Watch). The wireless device can connect to base stations (not shown), which can represent evolved NodeBs (eNodeBs or eNBs), for 4G LTE cellular wireless networks, and/or next generation NodeBs (gNodeBs or gNB), for 5G NR cellular wireless networks. A mobile network operator (MNO) can deploy the cellular wireless network with overlapping RATs to provide connections to wireless devices 102 with various capabilities and to transition gradually from older RATs to newer RATs. The MINO can configure priorities for use of different RATs and different radio frequency (RF) bands within a RAT by a wireless device 102. MINO configurations can be stored in the wireless device 102 in a carrier configuration file. The MNO can expect that a wireless device 102, while in an idle state (associated with the MNO's cellular wireless network but without an active data/voice connection), can camp on (associate with) the cellular wireless network using a 5G NR RAT (when the wireless device 102 is capable of using 5G NR) as long as cell selection criteria (also referred to as S-criteria), which are based on signal strength, such as a reference signal received power (RSRP) level, and/or on signal quality, such as a signal to noise plus interference (SINR) level, are satisfied. The MINO can configure handover criteria, such as for an A4 event regarding an intra-RAT neighbor cell satisfying a threshold or a B1 event regarding an inter-RAT neighbor cell satisfying a threshold, which can determine whether to handover a wireless device 102, while in a connected state, from a serving cell to a neighbor cell. Similarly, reselection involves switching between a serving cell and a neighbor cell while the wireless device 102 is in an idle state. Connecting to cells and switching between cells based on signal strength and/or signal quality prioritizes continuity of radio connections and quality of service for a wireless device 102.

Maintaining a connection with a serving cell of a particular RAT, within a particular RF band, or with a particular RF bandwidth, however, may cause the wireless device 102 to consume more power, from a limited supply of stored battery power available in the wireless device 102, than transferring an existing connection to (or camping on) a neighbor cell, that uses a different RAT, a different RF band, or a different RF bandwidth, in some circumstances. A lower RF band within a RAT, e.g., for a 4G LTE RAT or a 5G NR RAT, can be configured as a lowest priority option over use of a higher RF band. In some cases, network handover from a 5G NR RAT to a 4G LTE RAT may occur only if the 5G NR RAT is not able to provide acceptable voice quality, based on performance metrics set by the MNO, even though the 4G LTE RAT may provide adequate (or comparable or better) voice connections in some circumstances. A higher RF band can be configured to use carriers with wider bandwidths than a lower RF band within the same RAT. For example, an MNO can configure a 5G NR cellular wireless network to use the N41 time-division duplex (TDD) RF band at 2496 to 2690 MHz with 100 MHz wide carriers and the N28 frequency-division duplex (FDD) RF band at 703 to 803 MHz with 30 MHz wide carriers. Both the N41 TDD RF band and the N28 FDD RF band of the 5G NR cellular wireless network can be deployed in parallel with overlapping cell regions. Similarly, an MNO can configure a 5G NR cellular wireless network to use the N78 TDD RF band at 3300 to 3800 MHz with 100 MHz wide carriers and the N1 FDD RF band at 1920 to 2170 MHz with 40 MHz wide carriers. Connecting at the higher RF bands, which can be configured with higher priority than the lower RF bands, can cause the wireless device 102 to consume higher amounts of battery power due to use of wider RF bandwidth carriers for the higher RF bands. Alternatively, in some cases, connections to a lower RF band cell can cause the wireless device 102 to consume higher amounts of limited battery power due to transmit signal power levels required to maintain a quality connection with the lower RF band cell. Lower RF band cells can cover larger geographic areas, with higher inter-cell site distances and more wireless devices 102 operating in far cell conditions that require higher transmit power levels. As described herein, prioritization of the use of RATs, RF bands, RF bandwidths, and/or reselection/handover between intra-RAT or inter-RAT cells based on predicted and/or actual power consumption by a wireless device (or other monitored metrics that reflect power consumption by the wireless device and referred to herein as power consumption based mobility) can provide for more power efficient cellular wireless service than solely using signal strength/quality based mobility.

As illustrated in FIG. 1, higher RF band 5G NR cells can cover smaller geographic areas than lower RF band 5G NR cells or lower RF band 4G LTE cells. Both the higher RF band 5G NR cells and the lower RF band 5G NR or 4G LTE cells can be deployed by the same MNO and provide cellular wireless service to the wireless device 102. The wireless device 102 can encounter different radio conditions for connecting to the higher RF band 5G NR cells than the lower RF band 5G NR or 4G LTE cells at different positions (geographic locations). At a first position A, the wireless device 102 can be operating at a geographic location in which the wireless device 102 could connect to a near cell region 114 of a higher RF band 5G NR cell or to a far cell region 112 of a lower RF band 5G NR or 4G LTE cell. The higher RF band 5G NR cell may use wider bandwidth carriers but allow the wireless device 102, at position A, to use lower transmit power signal levels (being in a near cell region 114), while the lower RF band 5G NR or 4G LTE cell may use narrower bandwidth carriers but require the wireless device 102, at position A, to use higher transmit power signal levels (being in a far cell region 112). As such, the wireless device 102 can estimate power consumption before connecting to either cell (or while connected to one cell but considering switching to another cell) and include the estimated power consumption (or similar metrics that reflect power consumption) to determine to which cell to connect. At position B, the wireless device 102 can connect to a near cell region 110 of the lower RF band 5G or 4G LTE cell or to a far cell region 116 of the higher RF band 5G NR cell. In this case, connection to the lower RF band 5G or 4G LTE cell may provide lower power consumption for the wireless device 102, and the wireless device 102 can benefit from using power consumption based metrics in mobility decisions. At position C, the wireless device 102 can connect to the near cell region 110 of the lower RF band 5G or 4G LTE cell or to a near cell region 114 of the higher RF band 5G NR cell. Connecting to the lower RF band 5G or 4G LTE cell rather than the higher RF band 5G cell may provide lower power consumption for the wireless device 102. At position D, the wireless device 102 can connect to a far cell region 116 of the higher RF band 5G NR cell or to the far cell region 112 of the lower RF band 5G NR or 4G LTE cell. Connecting to either cell can require higher power for the wireless device 102 when operating in a far cell region rather than a near cell region, and by estimating power consumption for either connection, the wireless device 102 can determine a most power efficient connection. To estimate power consumption, the wireless device 102 can determine required transmit signal power levels for communicating with different cells and map the required transmit signal power levels to estimates of power consumption for the wireless device 102 to connect with and remain connected to the different cells. The wireless device 102 can include the power consumption estimates as part of a power consumption based mobility mechanism.

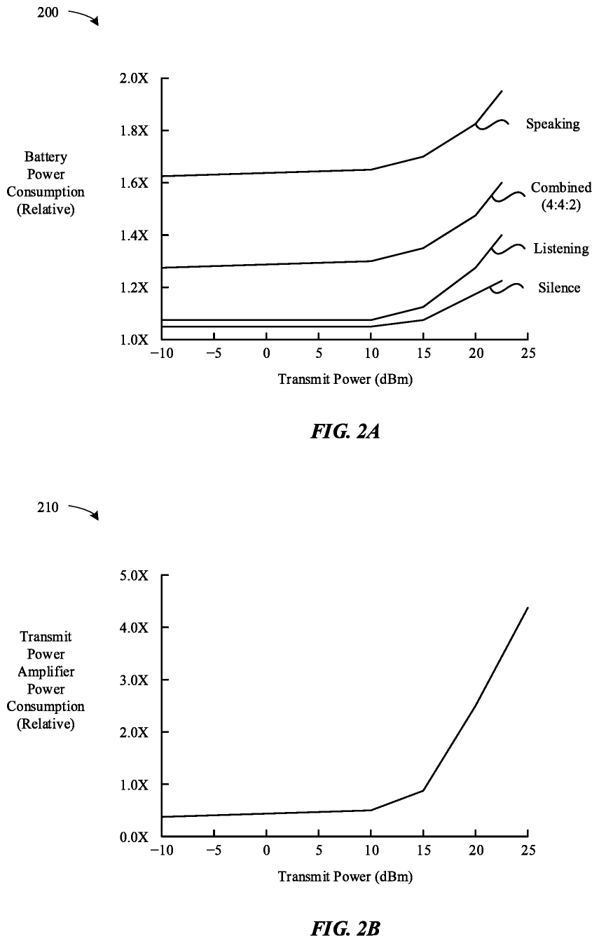

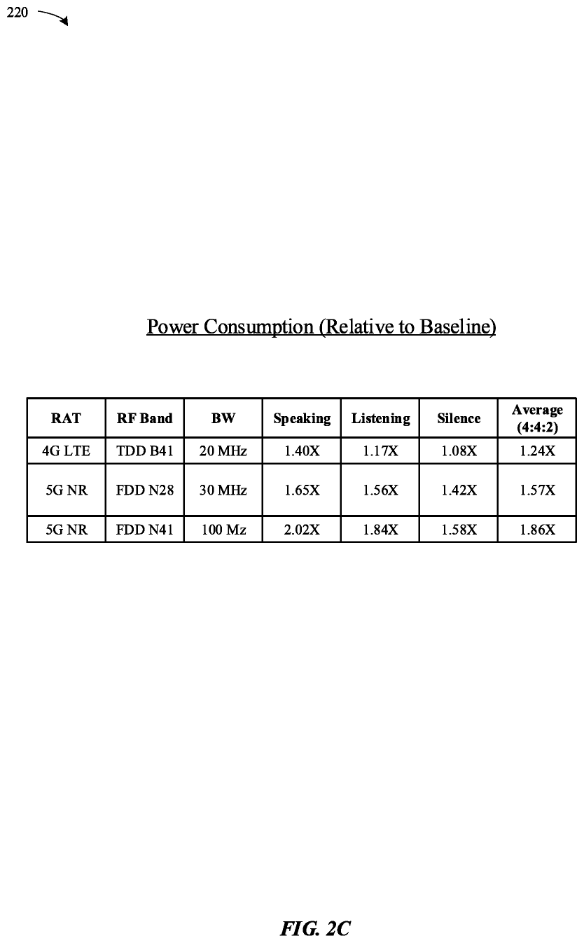

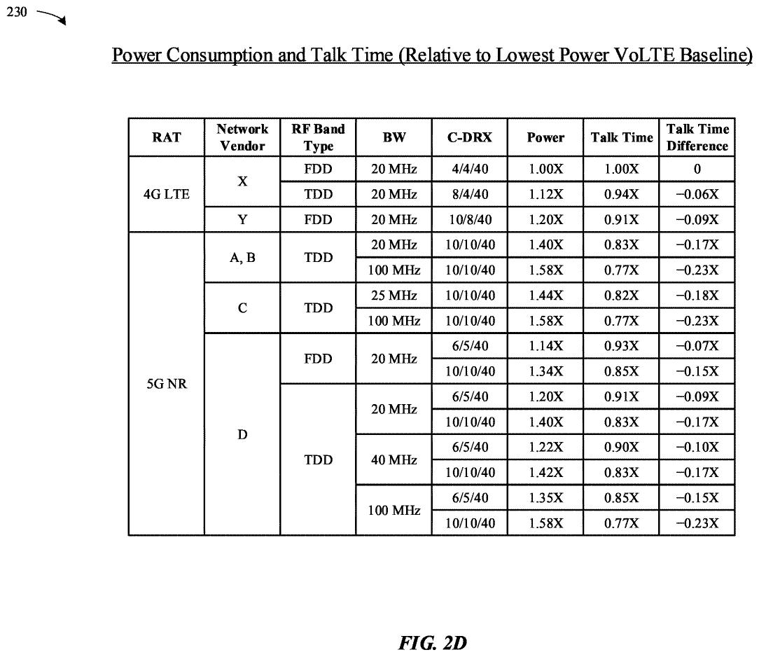

FIG. 2A illustrates a chart 200 of an exemplary battery power consumption for a wireless device 102 relative to different transmit power levels used by a transmitter of the wireless device 102 under different operating states while connected to a cellular wireless network for a voice connection. During a voice connection, the wireless device 102 can be in a “speaking” state, during which a local user of the wireless device 102 is speaking while a remote user is listening, a “listening” state, during which the local user of the wireless device 102 is listening while the remote user is speaking, and a “silence” state, during which both the local user and the remote user are not speaking. The power consumption rates are shown as relative values to a baseline power consumption level (1X) that can include other operations not related to baseband wireless communication, e.g., illuminating a display, executing application on an applications processor, etc. While in a silence state during a voice connection, the wireless device 102 consumes battery power at a lowest rate. While in a speaking or listening state during a voice connection, the wireless device 102 consumes more battery power, particularly when the local user of the wireless device 102 is speaking, which generates uplink data for transmission to the cellular wireless network. To approximate a mixed-use for cellular wireless communication capabilities, a combined power consumption can be derived by weighting the power consumptions for the different states: speaking, listening, and silence, using a 4:4:2 ratio. Notably, the battery power consumption rate is relatively flat when using a transmit power level less than 10 dBm and then climbs more steeply for increasing transmit power levels above 10 dBm, and particularly above 15 dBm. In far cell conditions, the wireless device 102 can be expected to consume a significant amount of additional battery power using higher transmit power levels compared to a near cell condition that supports lower transmit power levels. The wireless device 102, in some embodiments, can include a database, table, or function that maps transmit power levels to battery power consumption rates and can use the information in determining cell selection, re-selection, and handover decisions.

FIG. 2B illustrates a chart 210 of an exemplary power consumption by a transmit power amplifier (PA) when operating at different transmit power levels. The PA consumes significantly more power above 15 dBm and moderately more power above 10 dBm compared to lower transmit power levels. In some embodiments, the wireless device 102 can ignore a power consumption differential between a target cell and a serving cell when transmit signal power levels required for communication with the target cell and with the serving cell are both below a threshold transmit power level, such as 15 dBm or 10 dBm. Transmit power amplifier consumption amounts can be calculated by the wireless device 102 offline (or provided to the wireless device 102) and stored as a database, table, or function to use to map transmit power levels to transmit power amplifier consumption amounts. The transmit power amplifier module of the wireless device 102 can be measured offline. In some cases, power consumption by the transmit power amplifier can be relatively insensitive to RF bandwidth, to a radio access technology used, and/or to an RF band used within a frequency range (e.g., FR1 for 5G NR) and can primarily depend on the transmit signal power level required for communication with the cellular wireless network. Transmit power amplifier module power consumption measurements can be performed using slot level transmit signals, such as a physical uplink control channel (PUCCH) transmission and a physical uplink shared channel (PUSCH) transmission at various transmit levels. The wireless device can estimate a power consumption level for a target cell and for a serving cell by mapping required transmit power levels to communicate with each of the target cell and the serving cell to associated transmit power amplifier module power consumption values (a mapping for which can be stored in the wireless device 102).

FIG. 2C illustrates a table 220 of exemplary power consumption levels for a wireless device 102 (relative to a baseline 1X level) when using different RATs, different bandwidths, and in different RF bands under various operating conditions of a voice connection. As discussed for FIG. 2A, the wireless device 102 consumes more power when a local user of the wireless device 102 is speaking to a remote user than when the user of the wireless device 102 is listening to the remote user or when neither the local user or the remote user are speaking, and an average combined power consumption rate can be estimated using measurements under each operating condition. Power consumption using 5G NR with wider bandwidth carriers is higher than using 4G LTE with lower bandwidth carriers. In addition, using a higher RF 5G NR band, with wider bandwidth carriers, consumes more power than using a lower RF 5G NR band, with narrower bandwidth carriers.

FIG. 2D illustrates a table 230 of exemplary power consumption levels and continuous talk time values when communicating with different network vendor's equipment using different RF conditions, e.g., different RATs, RF bandwidths, and connected mode dynamic reception (C-DRX) configurations. An MNO can prefer to use a 5G NR RAT over a 4G LTE RAT for voice connections and can configure the wireless device 102 to use VoNR with a higher priority than VoLTE. Generally, the wireless device 102 can experience higher data performance during a VoNR voice connection than on a VoLTE voice connection, which can provide a higher quality of service for the user of the wireless device 102. Higher bandwidth carriers, e.g., using 100 MHz of RF bandwidth, result in higher power consumption levels for the wireless device 102, which can reduce a total amount of continuous talk time available for the wireless device 102. In addition, 5G NR C-DRX configurations can use higher values for an “on duration” timer and an “inactivity” timer than 4G LTE C-DRX configurations. Typically, a 5G NR C-DRX configuration uses 10 ms for the on duration timer, 10 ms for the inactivity timer, and 40 ms for each C-DRX cycle, while a 4G LTE C-DRX configuration can use 4 or 8 ms for the on duration timer and 4 ms for the inactivity timer in each 40 ms C-DRX cycle. As a result, a wireless device 102 using a typical 5G NR C-DRX configuration can remain in an awake (power-consuming) state rather than a sleep (power-reduced) state longer than using a typical 4G LTE C-DRX configuration. The differences in C-DRX configurations also contribute to different power consumption rates and resulting talk times available for the wireless device 102 as summarized in table 230 of FIG. 2D.

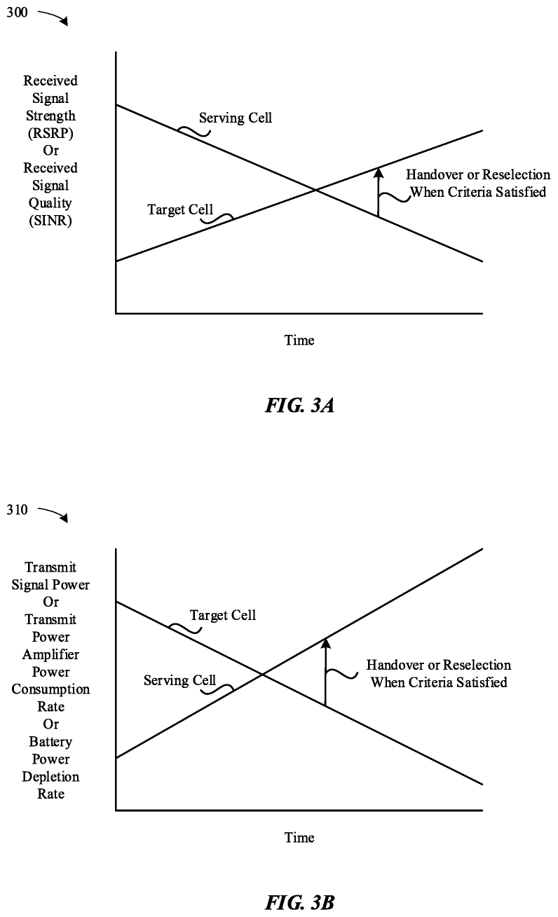

FIG. 3A illustrates a diagram 300 of an exemplary legacy handover (or reselection) between a serving cell and a target cell based on received signal measurements. A wireless device 102 can measure a received signal strength, e.g., a reference received signal power (RSRP) values, and/or a received signal quality, e.g., signal to interference plus noise ratio (SINR) values, for both a serving cell, on which the wireless device can be camped (in an idle state) or actively communicating with (in a connected state), and one or more neighbor cells, When handover or reselection criteria are satisfied, the wireless device 102 can move from the serving cell to a target (neighbor) cell. The legacy handover/reselection mechanism does not consider power consumption by the wireless device 102 and prioritizes signal connection strength and/or quality to determine which cell to use.

FIG. 3B illustrates a diagram 310 of a handover (or reselection) between a serving cell and a target cell based on power consumption based metrics. A wireless device 102 can monitor one or more power consumption based metrics, such as a transmit signal power level required to transmit with a cell, a transmit power amplifier (PA) power consumption rate based on the transmit signal power level required to transmit with the cell, or a battery depletion rate while connected to (or actively transmitting to) the cell. The wireless device 102 can monitor comparable metrics for a serving cell and for target (neighbor) cells. The wireless device 102 can determine whether to handover (while actively connected) or reselect (while in an idle state) from the serving cell to a target (neighbor) cell based on handover or reselection criteria are satisfied.

The wireless device can periodically measure received signal metrics for signals received from a serving cell and target (neighbor) cells, e.g., RSRP values and/or SINR values. The wireless device 102 can estimate required transmit signal power levels for communicating with the serving cell and with the measured target (neighbor) cells based on the received signal metrics. The wireless device 102 can then determine a power consumption estimate for remaining on the serving cell or switching to a target (neighbor) cell based on mapping the estimated target signal power levels to power consumption values, which can be calculated offline and accessed via a table or database stored in the wireless device 102. In some embodiments, the wireless device 102 calculates a power consumption differential between the serving cell and the target (neighbor) cell. In some embodiments, the wireless device 102 adjusts the power consumption differential by an offset value that can be based on configuration for communication with cells, e.g., a connected mode discontinuous reception (C-DRX) configuration, an RF bandwidth, and the like. The wireless device 102 can compare the power consumption differential (with or without the offset) to a power consumption threshold to determine whether to switch from the serving cell to the target cell. In some embodiments, when the power consumption differential satisfies the power consumption threshold, e.g., a target cell has a power consumption lower than the serving cell by at least threshold power consumption threshold (or by an adjusted threshold that accounts for the offset), the wireless device 102 can trigger a potential handover or reselection from the serving cell to the target cell, such as by sending a measurement report with priority to the serving cell of a cellular wireless network. In some embodiments, when the power consumption differential does not satisfy the power consumption threshold, the wireless device 102 blocks sending a measurement report to the serving cell of the cellular wireless network to allow the wireless device 102 to remain on the serving cell.

In some embodiments, a network entity of a cellular wireless network obtains received signal strength measurements for a serving cell and for one or more target (neighbor) cells and calculates a signal strength difference between the serving cell and each of the one or more target (neighbor) cells. The network entity can determine a transmit signal power level used by the wireless device 102 for communication in the serving cell, such as based on a power headroom (PHR) report provided by the wireless device 102. The network entity can estimate a transmit signal power level required for communication with the target (neighbor) cells based on the determined transmit signal power level for the serving cell and the signal strength differences (from received signals) between the serving cell and the target (neighbor) cells. The network entity can estimate power consumption differences for the wireless device 102 to communicate with the serving cell and with the target (neighbor) cells and determine whether to trigger a handover (or reselection) from the serving cell to a target (neighbor) cell when a power consumption difference between the serving cell and the target (neighbor) cell satisfies a power consumption threshold.

In some embodiments, the wireless device 102 (or the network entity) estimates power consumption for the wireless device 102 based on an estimated transmit signal power level and uses offline measurements of power consumption for a transmit power amplifier (PA) of the wireless device 102 (or representative of the transmit PA in the wireless device 102) taken at different transmit signal power levels. The power consumption values for the transmit PA can be stored in a database (table) in the wireless device 102 (or accessible to the wireless device 102) and provide a mapping from a transmit signal power level, e.g., in dBm, to a transmit PA power consumption rate, e.g., in mW. In some cases, the transmit PA power consumption is insensitive to RF bandwidth, RF band, and/or radio access technology (RAT) used. Power consumption measurements can be taken using slot level transmissions, such as for a physical uplink control channel (PUCCH) and a physical uplink shared channel (PUSCH) transmissions. In some embodiments, the power consumption rate of the transmit PA changes slowly at lower transmit signal power levels, such as below 10 dBm as shown in FIG. 2B, and increases at higher transmit signal power levels, above 10 dBm, or particularly above 15 dBm as shown in FIG. 2B. In some embodiments, the wireless device 102 does not trigger handover or reselection between a serving cell and a target (neighbor) cell based on power consumption estimates when the transmit signal power level for the serving cell and for the target cell both satisfy a transmit power threshold value, e.g., are below 10 or 15 dBm. While the wireless device 102 may not trigger handover or reselection between the serving cell and the target (neighbor) cell based on power consumption estimates, a handover or reselection may still occur based on legacy received signal strength/quality measurements, or order to provide quality of service for voice and/or data connections.

In addition to monitoring power consumption for switching between a serving cell and a target (neighbor) cell, a wireless device 102 can also prioritize use of different radio access technologies (RATs) for voice communication by the wireless device 102 based on various metrics. In field data observations indicate that most voice calls are relatively short in duration, and a user can experience higher quality voice connections via 5G NR with relatively minor amounts of power consumption. The wireless device 102 can prioritize use of a first RAT, e.g., 5G NR, for voice connections over a second RAT, e.g., 4G LTE, based on monitoring one or more metrics, such as cumulative voice call duration, estimated remaining call time available for a given battery power level, cumulative power consumption (for voice connections, for cellular communication, or for the device as a whole), or a battery power level. When the one or more metrics satisfy corresponding thresholds, the wireless device 102 can prioritize use of VoNR over use of VoLTE for voice connections. When one or more metrics do not satisfy corresponding thresholds, the wireless device 102 can prioritize use of VoLTE over the user of VoNR for voice connections. The wireless device 102 can monitor metrics during designated time periods and reset the metrics at the start of each subsequent time period, e.g., once per day, or after removal from an external power charger with a maximum charge level.

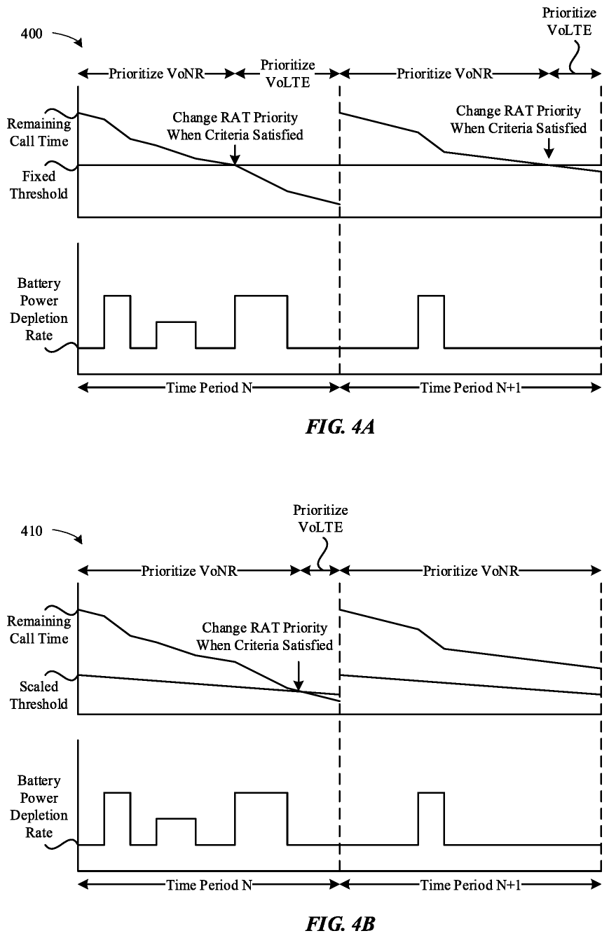

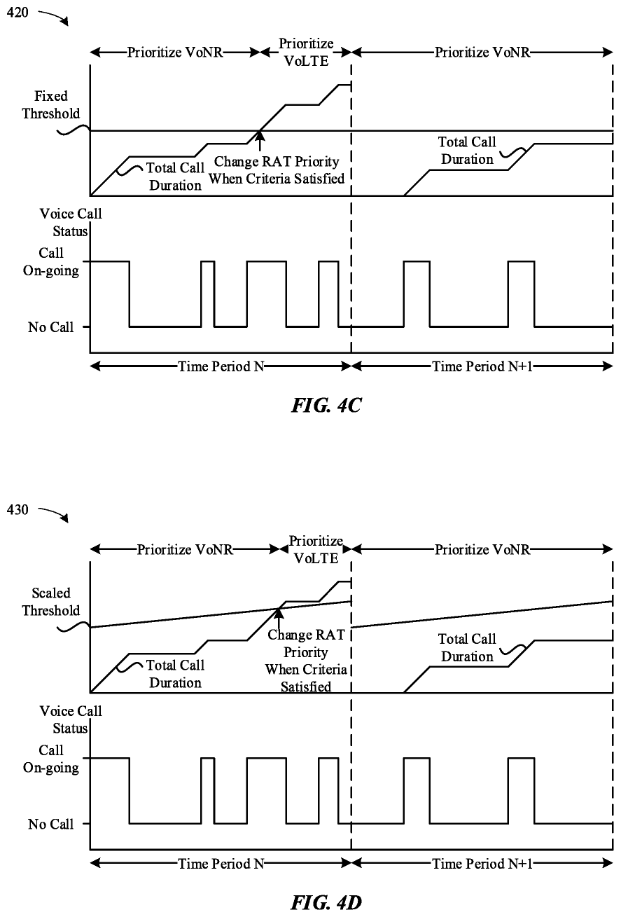

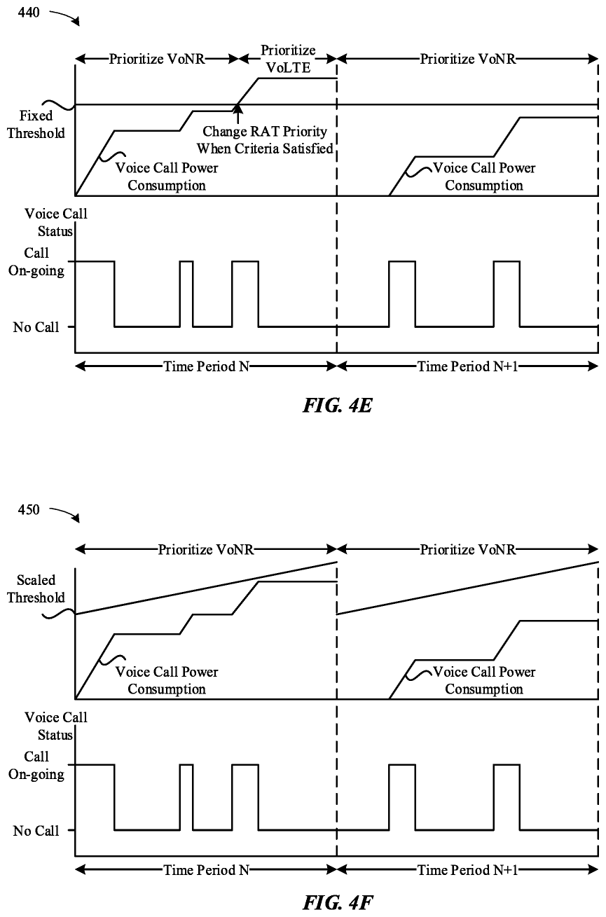

FIGS. 4A and 4B illustrate diagrams 400, 410 of exemplary RAT prioritization for voice connections based on an amount of remaining call time for a wireless device 102. The wireless device 102 can estimate the amount of remaining call time based on power metrics that are monitored by processors of the wireless device 102. In some embodiments, an applications processor monitors an amount of available battery power and can provide an estimate of battery power available to another processor (or use the estimate itself) when determining the amount of remaining call time. In some embodiments, a baseband processor of the wireless device 102 that manages baseband cellular wireless communication can monitor real-time power consumption for wireless communication and provide a long-term-averaged power consumption rate for wireless communication by the wireless device 102. In some embodiments, the wireless device 102 also accounts for power consumption of one or more functions other than baseband wireless communication and includes estimates for the “other” power consumption rate when determining an amount of call time remaining. In some embodiments, the wireless device 102 calculates the amount of remaining call time as an amount of available battery power divided by a combination of a power consumption rate for baseband wireless communication and a power consumption rate for one or more functions other than baseband wireless communication, such as for a screen display, execution of applications on an applications processor, one or more sensors, etc. The wireless device 102 can compare an amount or remaining call time to a call time threshold and determine to prioritize voice connections to use a first RAT, e.g., via VoNR, or voice connections to use a second RAT, e.g., via VoLTE. In some embodiments, when an amount of remaining call time does not satisfy a threshold (e.g., falls below a threshold), the wireless device prioritizes use of a second RAT with lower power consumption, e.g., 4G LTE, over use of a first RAT with higher power consumption, e.g., 5G NR. When the amount or remaining call time does satisfy the threshold (e.g., does not fall below the threshold), the wireless device 102 can prioritize voice connections to use the first RAT, e.g., 5G NR, over a second RAT, e.g., 4G LTE. In some embodiments, the threshold is a constant value during the designated time period. In some embodiments, the threshold is scaled by an amount of time remaining in the designated time period. In some embodiments, the designated time period is 24 hours.

FIG. 4A illustrates a diagram 400 of two successive time periods with a battery power depletion rate varying between different rates of power consumption during the time periods. The wireless device 102 calculates an amount of remaining call time, which can decrease based on the battery depletion rate throughout the time periods. The wireless device 102 can compare a current estimated remaining call time to a fixed threshold value and prioritize VoNR for voice connections when the amount of remaining call time does not fall below the fixed threshold value and prioritize VoLTE for voice connections when the amount of remaining call time does fall below the fixed threshold value. FIG. 4B illustrates a diagram 410 of a variant in which the fixed threshold value is replaced with a scaled threshold value, where the scaled threshold value decreases linearly throughout each time period. The scaled threshold decreases as the wireless device 102 is monitoring a monotonically decreasing amount of remaining call duration available to the wireless device 102 throughout the time period. With the same battery depletion rates as shown in FIG. 4A, the wireless device 102 is able to prioritize VoNR over VoLTE for a longer period of time in FIG. 4B as the scaled threshold allows for a lower amount of remaining call time to satisfy the threshold later in the time period. The monitored metric is reset at the start of each time period, and the scaled threshold, when used, restarts at an applicable value based on the amount of time remaining in the time period.

FIGS. 4C and 4D illustrate diagrams 420, 430 of exemplary RAT prioritization for voice connections based on a cumulative amount of call duration during a designated time period. The wireless device 102 monitors status for when a voice connection (call) is ongoing or no voice connection is taking place during the time period. The wireless device can measure a cumulative total amount of voice connection time during the time period and change prioritization for voice connections from a first RAT, e.g., 5G NR, to a second RAT, e.g., 4G LTE, based on comparing the total call duration for the time period to a threshold. In FIG. 4C, the threshold is a fixed value throughout the time period. In FIG. 4D, the threshold is linearly scaled based on an amount of time remaining in the time period. The scaled threshold increases throughout the time period, as the wireless device is tracking a monotonically increasing cumulative amount of call duration throughout the time period. With the same call durations as shown in FIG. 4C, the wireless device 102 is able to prioritize VoNR over VoLTE for a longer period of time in FIG. 4D as the scaled threshold allows for a higher amount of total call duration to satisfy the threshold later in the time period. The monitored metric is reset at the start of each time period, and the scaled threshold, when used, restarts at an applicable value based on the amount of time remaining in the time period.

FIGS. 4E and 4F illustrate diagrams 440, 450 of exemplary RAT prioritization for voice connections based on a cumulative amount of power consumed by the wireless device 102 for voice connections. The wireless device 102 monitors status for when a voice connection (call) is ongoing or no voice connection is taking place during the time period. The wireless device can measure a cumulative total amount of power consumed by the wireless device 102 for voice connections during the time period and change prioritization for voice connections from a first RAT, e.g., 5G NR, to a second RAT, e.g., 4G LTE, based on comparing the cumulative voice connection power consumption for the time period to a threshold. In FIG. 4E, the threshold is a fixed value throughout the time period. In FIG. 4F, the threshold is linearly scaled based on an amount of time remaining in the time period. The scaled threshold increases throughout the time period, as the wireless device is tracking a monotonically increasing cumulative total amount of power consumption for voice connections throughout the time period. With the same call durations as shown in FIG. 4E, the wireless device 102 is able to prioritize VoNR over VoLTE for a longer period of time in FIG. 4F as the scaled threshold allows for a higher amount of total voice call power consumption to satisfy the threshold later in the time period. The monitored metric is reset at the start of each time period, and the scaled threshold, when used, restarts at an applicable value based on the amount of time remaining in the time period. In some embodiments, the scaled threshold is scaled based on an amount of battery power available in the wireless device 102.

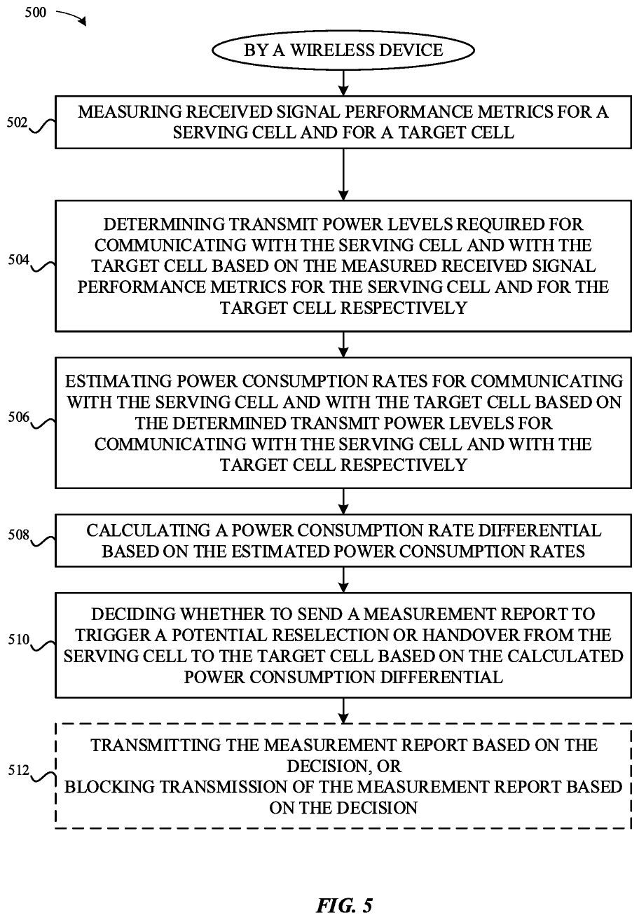

FIG. 5 illustrates a flowchart 500 of an exemplary method for power consumption based mobility by a wireless device 102. At 502, the wireless device 102 measures received signal performance metrics for a serving cell and for a target cell. At 504, the wireless device 102 determines transmit power levels required for the wireless device 102 to communicate with the serving cell can with the target cell based on the measured received signal performance metrics for the serving cell and the target cell respectively. At 506, the wireless device 102 estimates power consumption rates for the wireless device 102 to communicate with the serving cell and with the target cell based on the determined transmit power levels for communicating with the serving cell and with the target cell respectively. At 508, the wireless device 102 calculates a power consumption rate differential based on the estimated power consumption rates. At 510, the wireless device 102 decides whether to send a measurement report to a cellular wireless network to trigger a potential reselection or handover of the wireless device 102 from the serving cell to the target cell based on the calculated power consumption rate differential. At 512, the wireless device 102 transmits the measurement report based on the decision or blocks transmission of the measurement report based on the decision.

In some embodiments, the wireless device 102 estimates the power consumption rates from the transmit power levels based on a power consumption database calculated offline and stored in the wireless device 102. In some embodiments, the transmit power levels and power consumption rates are based on a combination of physical uplink control channel (PUCCH) and physical uplink shared channel (PUSCH) transmissions. In some embodiments, the wireless device 102 triggers the potential reselection or handover by comparing the power consumption rate differential to a power consumption threshold. In some embodiments, the power consumption rate differential includes a difference between the power consumption rate for communicating with the serving cell minus the power consumption rate for communicating with the target cell plus an offset value. In some embodiments, the offset value is based on one or more of: a radio frequency band, a radio access technology, a radio frequency bandwidth, or a connected mode discontinuous reception (C-DRX) configuration. In some embodiments, the wireless device 102 sends the measurement report to the serving cell with priority when the power consumption rate differential exceeds a power consumption threshold. In some embodiments, the wireless device 102 blocks the measurement report for the serving cell when the power consumption rate differential does not exceed a power consumption threshold. In some embodiments, the wireless device calculates the power consumption rate differential to a pre-determined value that does not trigger reselection or handover when the transmit power level for the serving cell and the transmit power level for the target cell each do not satisfy a minimum transmit power threshold. In some embodiments, the minimum transmit power threshold is 10 or 15 dBm.

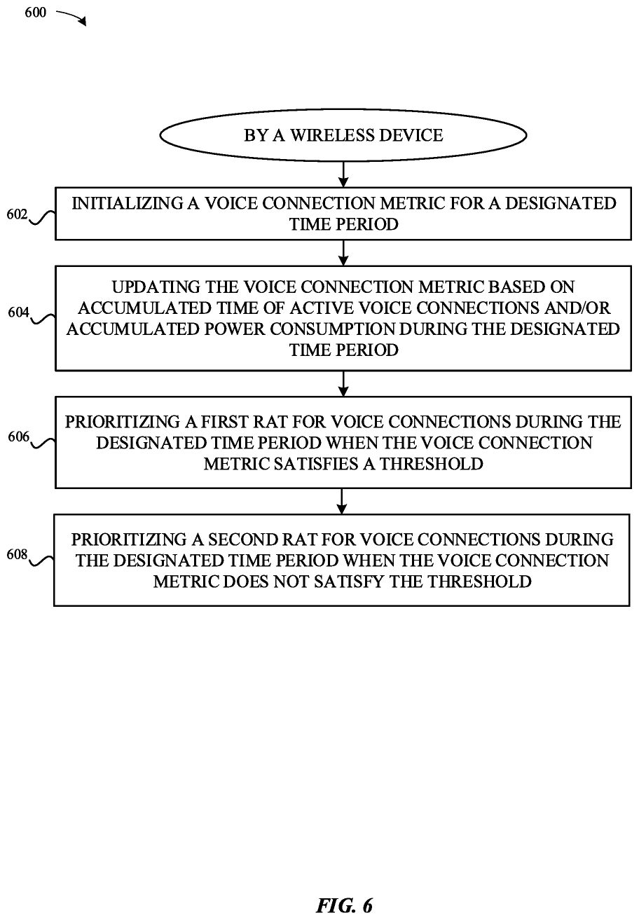

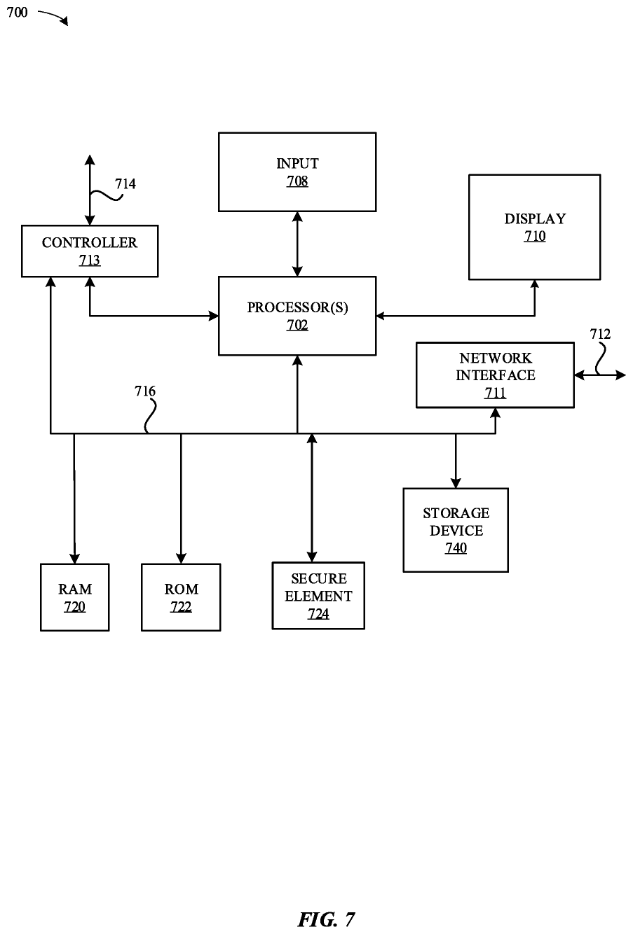

FIG. 6 illustrates a flowchart 600 of an exemplary method for adaptive RAT prioritization for voice connections by a wireless device 102. At 602, the wireless device 102 initializes a voice connection metric for a designated time period. At 604, the wireless device 102 updates the voice connection metric based on accumulated time of active voice connections and/or accumulated power consumption during active voice connections during the designated time period. At 606, the wireless device 102 prioritizes a first RAT for voice connections during the designated time period when the voice connection metric satisfies a threshold. At 608, the wireless device 102 prioritizes a second RAT for voice connections during the designated time period when the voice connection metric does not satisfy the threshold.

In some embodiments, the wireless device 102 re-initializes the voice connection metric for each subsequent designated time period. In some embodiments, each designated time period includes twenty-four hours. In some embodiments, the voice connection metric includes the accumulated time of active voice connections using the first RAT during the designated time period, and the voice connection metric satisfies the threshold when the voice connection metric does not exceed the threshold. In some embodiments, the voice connection metric includes an estimated remaining amount of voice connection time available for using the first RAT in the designated time period, and the voice connection metric satisfies the threshold when the voice connection metric exceeds the threshold. In some embodiments, the voice connection metric includes the accumulated power consumption for active voice connections using the first RAT during the designated time period, and the voice connection metric satisfies the threshold when the voice connection metric does not exceed the threshold. In some embodiments, the threshold is a constant value throughout the designated time period. In some embodiments, the threshold is scaled based on a remaining amount of time during the designated time period. In some embodiments, the threshold is scaled based on an amount of stored battery power available for the wireless device.

FIG. 7 illustrates a detailed view of a representative computing device 700 that can be used to implement various methods described herein, according to some embodiments. In particular, the detailed view illustrates various components that can be included in a wireless device 102. As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Still further, the computing device 700 can include a display 710 that can be controlled by the processor 702 to display information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that communicatively couples to a data link 712. In the case of a wireless connection, the network/bus interface 711 can include a wireless transceiver.

The computing device 700 also includes a storage device 740, which can comprise a single disk or a plurality of disks (e.g., hard drives), and includes a storage management module that manages one or more partitions within the storage device 740. In some embodiments, storage device 740 can include flash memory, semiconductor (solid state) memory or the like. The computing device 700 can also include a Random Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700. The computing device 700 can further include a secure element (SE), such as an eUICC, a UICC, or another secure storage for cellular wireless system access by a wireless device 102.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for power consumption based mobility for a wireless device, the method comprising:
measuring received signal performance metrics for a serving cell and for a target cell;
determining transmit power levels required for communicating with the serving cell and with the target cell based on the measured received signal performance metrics for the serving cell and for the target cell respectively;
estimating power consumption rates for communicating with the serving cell and with the target cell based on the determined transmit power levels for communicating with the serving cell and with the target cell respectively;
calculating a power consumption rate differential based on the estimated power consumption rates; and
deciding whether to send a measurement report to trigger a potential reselection or handover from the serving cell to the target cell based on the calculated power consumption rate differential.

2. The method of claim 1, further comprising, based on the deciding:
transmitting the measurement report; or
blocking transmission of the measurement report.

3. The method of claim 1, wherein estimation of the power consumption rates from the transmit power levels is based on a power consumption database calculated offline and stored in the wireless device.

4. The method of claim 3, wherein the transmit power levels and power consumption rates are based on a combination of physical uplink control channel (PUCCH) and physical uplink shared channel (PUSCH) transmissions.

5. The method of claim 1, further comprising:
triggering the potential reselection or handover by comparing the power consumption rate differential to a power consumption threshold.

6. The method of claim 1, wherein the power consumption rate differential comprises a difference between the power consumption rate for communicating with the serving cell minus the power consumption rate for communicating with the target cell plus an offset value.

7. The method of claim 6, wherein the offset value is based on one or more of: a radio frequency band, a radio access technology, a radio frequency bandwidth, or a connected mode discontinuous reception (C-DRX) configuration.

8. The method of claim 6, further comprising:
sending the measurement report to the serving cell with priority when the power consumption rate differential exceeds a power consumption threshold; and
blocking the measurement report for the serving cell when the power consumption rate differential does not exceed a power consumption threshold.

9. The method of claim 1, further comprising:
calculating the power consumption rate differential to a pre-determined value that does not trigger reselection or handover when the transmit power level for the serving cell and the transmit power level for the target cell each do not satisfy a minimum transmit power threshold.

10. The method of claim 9, wherein the minimum transmit power threshold comprises 10 or 15 dBm.

11.-20. (canceled)

21. An apparatus configured for operation in a wireless device, the apparatus comprising one or more processors communicatively coupled to wireless circuitry and to a memory storing instructions, the apparatus configured to:
measure received signal performance metrics for a serving cell and for a target cell;
determine transmit power levels required for communicating with the serving cell and with the target cell based on the measured received signal performance metrics for the serving cell and for the target cell respectively;
estimate power consumption rates for communicating with the serving cell and with the target cell based on the determined transmit power levels for communicating with the serving cell and with the target cell respectively;
calculate a power consumption rate differential based on the estimated power consumption rates; and
decide whether to send a measurement report to trigger a potential reselection or handover from the serving cell to the target cell based on the calculated power consumption rate differential.

22. The apparatus of claim 21, wherein the apparatus is further configured to, based on the deciding:
transmit the measurement report; or
block transmission of the measurement report.

23. The apparatus of claim 21, wherein estimation of the power consumption rates from the transmit power levels is based on a power consumption database calculated offline and stored in the wireless device.

24. The apparatus of claim 23, wherein the transmit power levels and power consumption rates are based on a combination of physical uplink control channel (PUCCH) and physical uplink shared channel (PUSCH) transmissions.

25. The apparatus of claim 21, wherein the apparatus is further configured to:
trigger the potential reselection or handover by comparing the power consumption rate differential to a power consumption threshold.

26. The apparatus of claim 21, wherein the power consumption rate differential comprises a difference between the power consumption rate for communicating with the serving cell minus the power consumption rate for communicating with the target cell plus an offset value.

27. The apparatus of claim 26, wherein the offset value is based on one or more of: a radio frequency band, a radio access technology, a radio frequency bandwidth, or a connected mode discontinuous reception (C-DRX) configuration.

28. The apparatus of claim 26, wherein the apparatus is further configured to:
send the measurement report to the serving cell with priority when the power consumption rate differential exceeds a power consumption threshold; and
block the measurement report for the serving cell when the power consumption rate differential does not exceed a power consumption threshold.

29. The apparatus of claim 21, wherein the apparatus is further configure to:
calculate the power consumption rate differential to a pre-determined value that does not trigger reselection or handover when the transmit power level for the serving cell and the transmit power level for the target cell each do not satisfy a minimum transmit power threshold.

30. A wireless device comprising:
wireless circuitry comprising one or more antennas; and
one or more processors communicatively coupled to the wireless circuitry and to a memory storing instructions that, when executed by the one or more processors, configure the wireless device to:
measure received signal performance metrics for a serving cell and for a target cell;
determine transmit power levels required for communicating with the serving cell and with the target cell based on the measured received signal performance metrics for the serving cell and for the target cell respectively;
estimate power consumption rates for communicating with the serving cell and with the target cell based on the determined transmit power levels for communicating with the serving cell and with the target cell respectively;
calculate a power consumption rate differential based on the estimated power consumption rates; and
decide whether to send a measurement report to trigger a potential reselection or handover from the serving cell to the target cell based on the calculated power consumption rate differential.
